(19) United States
(12) Patent Application Publication
(10) Pub. No.: US 2026/0257306 A1
(43) Pub. Date: Sep. 3, 2026

(54) INSTALLATION TOOL FOR A CLAMPING SYSTEM OF A MACHINE SPINDLE

(71) Applicants: Tony J. Wensman, Sartell, MN (US); Andrew T. Wensman, Sartell, MN (US)

(72) Inventors: Tony J. Wensman, Sartell, MN (US); Andrew T. Wensman, Sartell, MN (US)

(21) Appl. No.: 19/554,139

(22) Filed: Mar. 2, 2026

Related U.S. Application Data
(60) Provisional application No. 63/764,971, filed on Feb. 28, 2025.

(51) Int. Cl. B23P 19/04; B23P 15/00

(52) U.S. Cl. CPC B23P 19/04; B23P 15/00

(57) ABSTRACT

A clamp set installation device for a machine spindle is provided. The installation device has a compression body configured to thread onto the drawbar of the machine spindle so that a distal edge of the compression body compresses a clamp set's spring-loaded spacer within the spindle bore. The installation device includes a sleeve linearly slidable relative to the compression body. The distal portion of the sleeve provides an access ramp on which a gripping segment can be seated during installation into the compressed spring-loaded spacer. The access ramp is oriented at a sufficient angle so that a distal portion of the seated gripping element is guided at an entry angle sufficient to slide around the shoulder of the spindle bore that facilitates a locked engagement of the gripper segment between the spring-loaded spacer and the shoulder. The sleeve is rotatable for sequentially installing the next gripping segment.

### CROSS REFERENCE TO RELATED APPLICATION

This application claims the benefit of priority of U.S. provisional application No. 63/764,971, filed Feb. 28, 2024, the contents of which are herein incorporated by reference.

### BACKGROUND OF THE SUBJECT DISCLOSURE

The subject disclosure relates to devices for machine spindles and, more particularly, to an installation tool for installing a clamping system for a tool holding portion of a machine spindle.

It is critical that computer numerical control (CNC) machining is precise and reliable during the manufacturing of complex parts. CNC machining relies on precision machine tool holders that clamp machining tools to the machine spindle. For many tool-holding systems designed for high-speed CNC machining, dual-contact taper and flange configurations are utilized. An example of a clamp set embodying such a configuration is HSK. HSK stands for “Hollow Taper Shank” and provides a specialized, lightweight tool holder interface used in high-speed CNC machining.

Specifically, HSK toolholders use a dual-contact clamping system that engages both the spindle taper and the flange face of the spindle simultaneously. When the toolholder is inserted into the spindle, a set of gripping segments or collet fingers inside the spindle bore are actuated—typically by a drawbar mechanism driven by springs or hydraulics. These segments expand outward and grip the inside of the hollow HSK shank, pulling it firmly into the spindle taper while simultaneously pressing the flange face flat against the spindle nose, creating that critical two-point contact. The result is excellent tool runout accuracy, strong resistance to torque and bending forces, and very consistent tool-length repeatability from one tool change to the next.

Hand in hand with precision, consistent output is proper maintenance of the tool holding assembly. Maintenance requires removing the three main components of the tool holding assembly—the spindle cone, the plurality of gripping segments, and the spring-loaded spacer—and checking for wear and tear, removing debris, and applying lubricant.

The gripping segments (also called clamping fingers or collet segments) are a segmented ring of three or more individual hardened steel fingers arranged radially around a central drawbar/actuating cone. The spring-loaded spacer sits between or behind the gripping segments. The spring-loaded spacer is pushing the gripping segments forward (toward the nose of the spindle) and radially outward against the inner bore ramp of the HSK shank. Because the bore of the HSK shank has a slight internal taper or groove geometry, the outward radial force from the segments—when the drawbar is in an activated state—causes them to bite into that bore, pulling the shank hard back into the spindle taper simultaneously.

Also critically, after maintenance of the main components of the tool holding assembly in a disassembled condition, the tool holding assembly needs to be reassembled through proper installation. That, however, can be a challenge for a host of reasons: namely, the gripping segments must be installed one at a time when the drawbar is in a deactivated state; the tight cavernous space of the spindle bore makes it difficult to shine sufficient light therein; and the orientation of the operative machine spindle could demand that the installer is working upside down. Proper installation, again, requires critical adjustments to the tool holding portion to ensure that the spindle functions optimally and safely. There is also a critical distance that the clamping cone must protrude from the clamp set beyond the spindle, which is another demand imposed on precise installation.

And of course, manufacturers cannot manufacture parts when their equipment is not yet reinstalled after their maintenance, and so it is very desirous for this accurate installation to be done as quickly, yet accurately, as possible by a maintenance technician or even a mom-and-power owner/operator.

To the inventors'knowledge, currently there are no tools made directly for installing HSK black (Model B) clamp sets. Rather, prior users would install each finger one at a time into the spindle with no device designed to keep the spring pressure of the spring-loaded spacer compressed, which is what facilities the gripper segments to be reinstalled easily. These prior solutions demanded that the re-installer had to hold every gripper segment (seven gripper segments in total for the HSK black Model B clamp sets) all at once while inserting them into a tight, dark longitudinal bore in the face of high spring pressure. The constant pressure on one's hands when trying to overpower the spring-loaded spacer often generates fatigue on the technician.

As can be seen, there is a need for a clamp set installation device purposed to facilitate quick and easy reinstallation of self-releasing machine taper clamp sets of a machine spindle.

### SUMMARY OF THE SUBJECT DISCLOSURE

In one aspect of the subject disclosure, a device for installing gripping segments of a clamping set for a machine spindle includes the following: a compressor body having a shaft along which a sleeve is linearly movable relative to the shaft; a distal portion of the compressor body configured to simultaneously (a) compress a spring of a spring-loaded spacer of said clamping set; and (b) engage a drawbar of said machine spindle; and the sleeve having an access ramp along a distal end thereof, wherein the access ramp is configured to directly engage a gripping segment of said clamping set while operatively associating said gripping segment with the spring-loaded spacer.

In yet another aspect of the subject disclosure, the above identified device further includes wherein the distal portion defines a cavity having internal threads for threading onto said drawbar, wherein the access ramp has a radius of curvature between a flat portion of the access ramp and an exterior wall of the sleeve, wherein linear movement of the sleeve relative the shaft is deployed during operatively associating said gripping segment with the spring-loaded spacer, wherein the sleeve is rotatable relative the shaft about a longitudinal axis thereof; further including an indicator integrated to a proximal portion of the sleeve, wherein the indicator linearly aligns with the access ramp; and a radial flange along the proximal portion of the sleeve, wherein the indicator is a flat portion of the radial flange, wherein the sleeve is biased in a relative direction of the distal portion of the compression body; and further including a grip knob connected to a proximal portion of the compressor body; and a spring operatively associated to the grip knob and the radial flange to bias the sleeve.

In yet another aspect of the subject disclosure, a method of installing a gripping segment into a spring-biased spacer operatively associated within a machine spindle includes the following: compressing a spring of the spring-biased spacer with a distal portion of a tool, wherein the tool is simultaneously thread connected to a drawbar of the machine spindle; and operatively associating the gripping segment with the spring-biased spacer by way of an access ramp provided by the tool, wherein the access ramp orients the gripping segment at a non-parallel angle relative to the distal portion of the tool during said operative association.

These and other features, aspects and advantages of the subject disclosure will become better understood with reference to the following drawings, description and claims.

### BRIEF DESCRIPTION OF THE DRAWINGS

FIG. 1A is a perspective view of an exemplary embodiment of a clamp set installation device of the subject disclosure.

FIG. 1B is a side elevation view of an exemplary embodiment of the clamp set installation tool of the subject disclosure.

FIG. 1C is a cross-sectional view of FIG. 1B taken along line 1C-1C.

FIG. 2A is a perspective view of an exemplary embodiment of a grip knob of the subject disclosure.

FIG. 2B is a sectional view of an exemplary embodiment of the grip knob of the subject disclosure.

FIG. 3A is a perspective view of an exemplary embodiment of a sleeve of the subject disclosure.

FIG. 3B is an elevation view of an exemplary embodiment of the sleeve of the subject disclosure that utilizes ghost lines to indicate internal structure and architecture.

FIG. 3C is a perspective view of an exemplary embodiment of a sleeve of the subject disclosure.

FIG. 3D is an elevation view of an exemplary embodiment of the sleeve of the subject disclosure that utilizes ghost lines to indicate internal structure and architecture.

FIG. 4 is a section view of an exemplary embodiment of a spring compressor of the subject disclosure.

FIG. 5A is a section view of an exemplary embodiment of a fully operational self-releasing clamp set, including a spindle cone 12 operatively associated with a tool coupler 28.

FIG. 5B is a section view of an exemplary embodiment of the self-releasing clamp set, with the spindle cone and tool coupler removed, and with the clamp set installation device 100 engaged with the spring-loaded spacer 30, thereby the installation device 100 is enabled to install, one by one, the gripping segments 14 into the spring-loaded spacer 30 in an operatively associated manner.

FIG. 6A is a side elevation view of an exemplary embodiment of a clamp set installation device 100 of the subject disclosure.

FIG. 6B is a cross-sectional view of FIG. 6A taken along line 6B-6B.

FIG. 7A is a perspective view of an exemplary embodiment of an alternative grip knob of the subject disclosure.

FIG. 7B is a sectional view of an exemplary embodiment of the alternative grip knob of the subject disclosure.

FIG. 8A is a perspective view of an exemplary embodiment of an alternative sleeve of the subject disclosure.

FIG. 8B is a sectional view of an exemplary embodiment of the alternative sleeve of the subject disclosure.

FIG. 9A is a perspective view of an exemplary embodiment of an alternative spring compressor of the subject disclosure.

FIG. 9B is a side elevation view of an exemplary embodiment of the alternative spring compressor of the subject disclosure.

FIG. 9C is a front-end view of an exemplary embodiment of the alternative spring compressor of the subject disclosure.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

As used herein, directional terms such as upper, lower, upward, downwardly, top, left, right and the like are used in relation to the illustrative embodiments as they are depicted in the figures, such that the upward direction (or upper) being toward the top of the corresponding figures and the downward direction being toward the bottom of the corresponding figures.

A general overview of the various features of the subject disclosure will be provided, with a detailed description following. Broadly, an embodiment of the subject disclosure provides a machine spindle clamp set installation device.

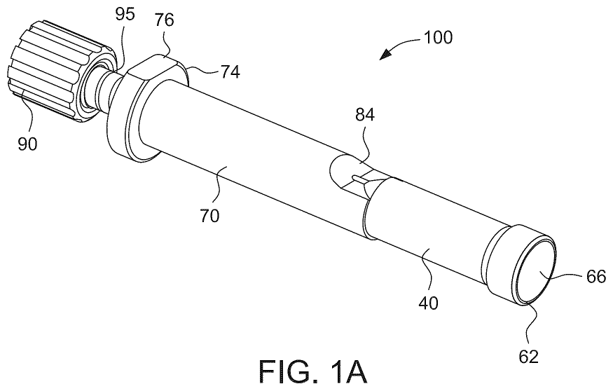

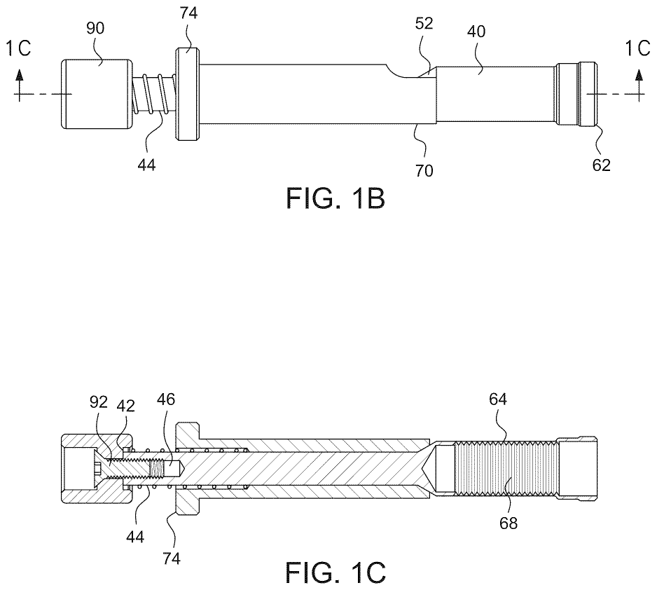

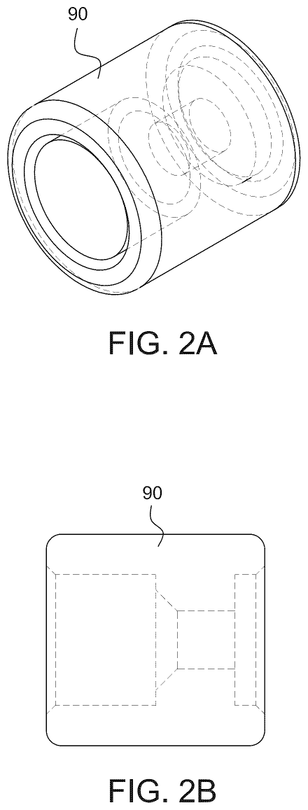

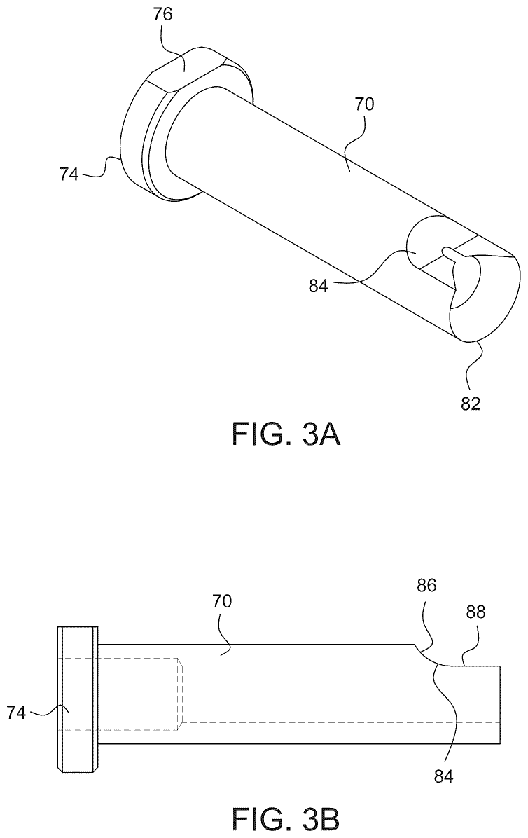

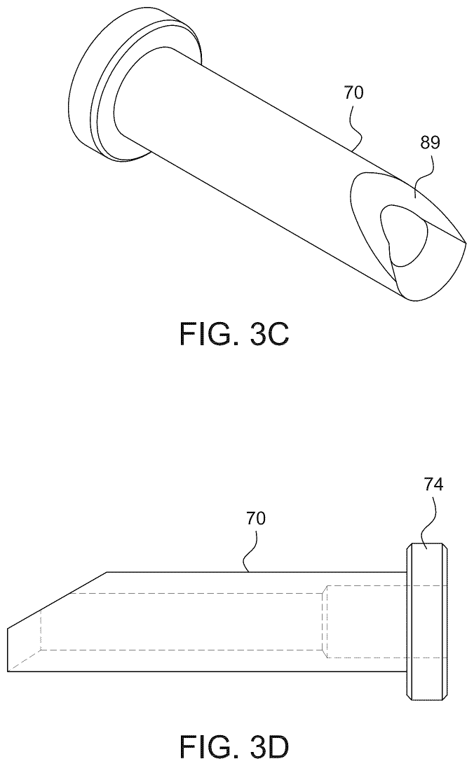

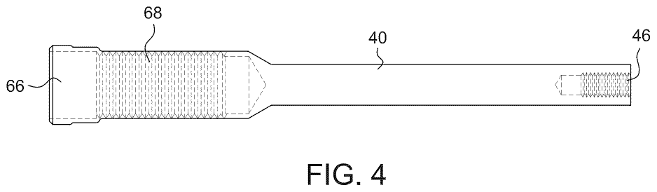

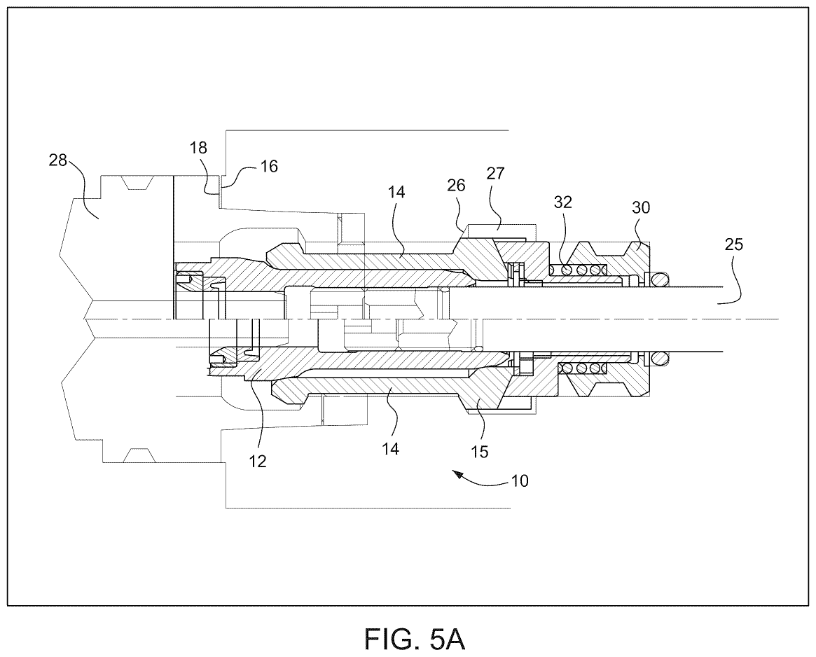

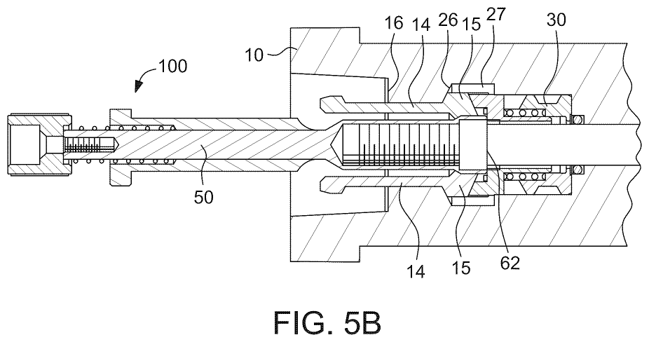

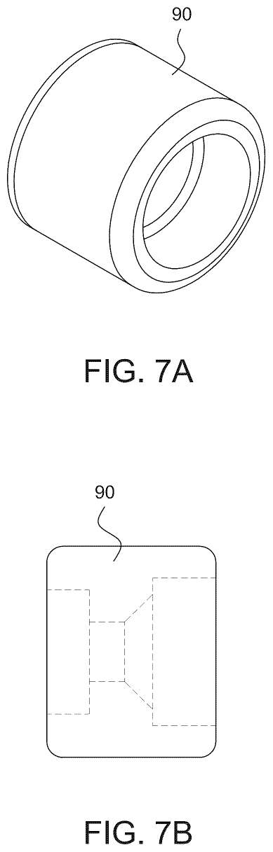

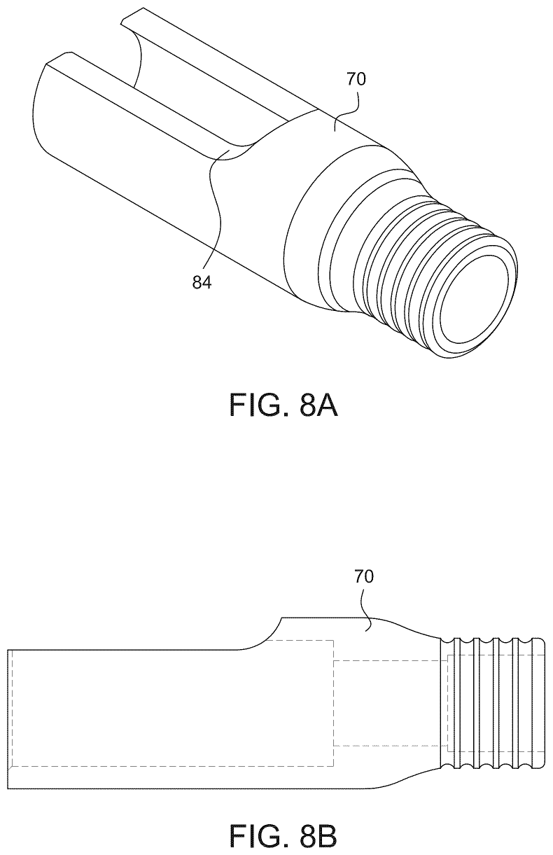

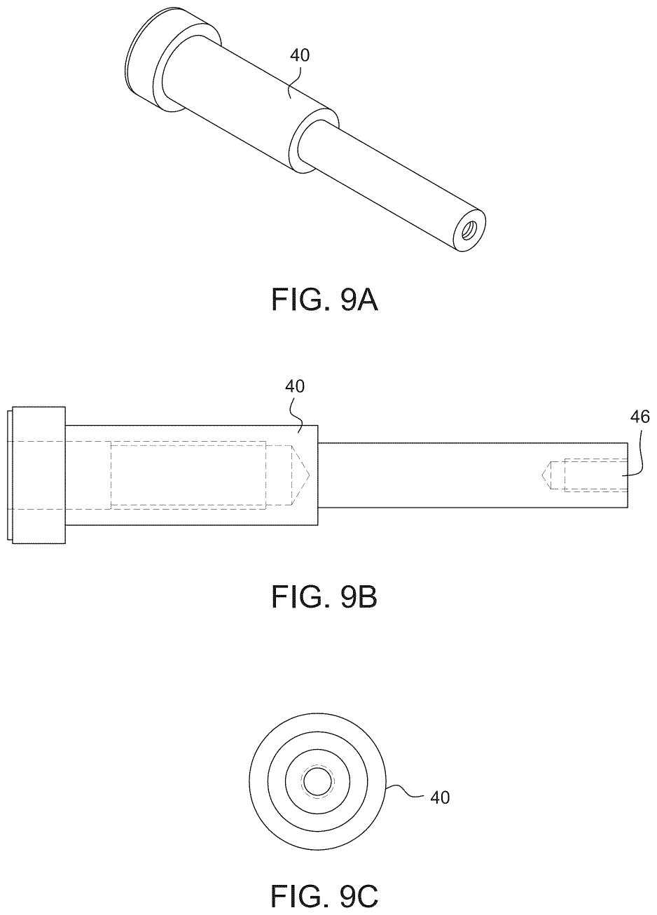

Referring now to FIGS. 1A through 9C, the subject disclosure may include the installation device 100 for a machine spindle 10. The installation device 100 may include a compression body 40 slidable, in part, within a sleeve 70. The compression body 40 extends between a proximal end 42 to a distal end 62. The distal end may be dimensioned, shaped, and adapted to operatively associated with a spring-loaded spacer 30 of the machine spindle 10 to move the spring 32 of the spring-loaded spacer 30 into a compressed condition.

Distal end 62 may be part of a distal portion 64 defining a cavity 66, which an opening of the distal end 62 communicates with. The cavity 66 provides internal threads 68 dimensioned and adapted to cooperate with threads (not shown) of a drawbar 25 of the machine spindle 10. The internal threads 68, in one embodiment, may be tapped with M14×1.5 mm thread; though, it is understood that other threading types can work if the internal thread matches the thread on the spindle drawbar 25. A proximal portion 44 of the compression body 40 may also have an open-end cavity 46 for receiving a fastener 92 for a grip knob 90 to connect to and project from the proximal end. In between the proximal and distal portions 44 and 64 is an interconnecting shaft 50.

The sleeve 70 slides along the shaft 50 and possibly along a portion of the proximal portion 44 of the compression body 40. A proximal end 82 of the sleeve 70 provides a flange 74. On the opposing distal end 82 of the sleeve 70 is an access ramp 84 recessed into the otherwise cylindrical body of the sleeve 70. The distal end 82 of the sleeve 70 may be dimensioned and adapted to engage a proximal-facing conic section/end 52 of the compression body 40 (this is where the distal end 82 of the sleeve 70 interfaces the shaft 50). The conic section 52 provides a stop to the distal end 82 of the sleeve 70. Along the radially extending flange 74 may be an indicator edge 76, which aligns with the spaced apart access ramp 84. This alignment allows an installer to know where the access ramp 84 is located during installation when the distal end 82 may be embedded in the dark longitudinal bore 22 of the spindle 10

There are different possible embodiments of the access ramp 84. The one shown in FIGS. 1A 1B, 3A, and 3B have a radius of curvature 86 that transitions from the cylindrical wall of the sleeve 70 to a flat portion 88. The radius of curvature 86 may range from approximately 6.35 millimeters (mm) to approximately 9.535 mm. The flat portion 88 may have a length that ranges between 7.94 mm and 31.75 mm. The radial distance between the cylindrical wall and the flat portion 88 may be approximately three to four mm. In other embodiments, the access ramp 84 may be an angled plane 89 of approximately 45-degrees from the cylindrical wall to a distal edge of the sleeve 70.

A flange spring 95 may be disposed along the shaft 50 between the flange 74 and the grip knob 90 so that the sleeve 70 is spring biased toward the distal portion 64 of the compression body 40. The installer can overcome this bias when handling the grip knob 90 and the flange 74. The sleeve 70 is operatively associated with the shaft 50 of the compression body 40 so as be linearly movable relatively thereto (in the direction of the spring bias) as well as rotationally. Meaning the sleeve 70 may be rotated about the longitudinal axis of said sleeve 50 while the distal portion 64 of the compression body 40 is threaded to the drawbar 25 and compressing the spring 32 of the spring-loaded spacer 30.

In operation, with the drawbar 25 deactivated and with the spindle cone 12 and the gripper segments 14 removed, the distal portion 64 of the installation device 100 is threaded on to the drawbar 25 until the distal end 62 of the compression body 40 engages the spring-loaded spacer 30 to compress the spring 32 thereof. The non-compressed spring 32 is what locks gripper segments 14 to the spring-loaded spacer 30. More specifically, an engager 34 of the spring-loaded spacer 30, under the urging of the non-compressed spring 32, engages and urges a distal end 15 of each gripper segment 14 at/against a shoulder 26 within the longitudinal bore 22 of the spindle 20. And so, in a compressed condition by way of the distal end 62 of the compression body 40, the gripper segments 14 can be properly operatively associated with the spring-loaded spacer 30.

Getting the distal end 15 of the gripper segment (when, again, both the drawbar 25 is deactivated and the spring-loaded spacer 30 is in a compressed condition) under and around said shoulder 26 has been a big challenge in the prior art, especially considering the not-well-lit and tightly spaced environment the reinstallation of the clamp set takes place. Here, to overcome this challenge, the access ramp 84 provides a track to guide each gripper segment 14 at the requisite angle or orientation (the angle or radius of curvature of the access ramp 84 enables such requisite angle) when sliding toward the spring-loaded spacer 30. Specifically, the user aligns the access ramp 84 of insertion tool 100 with the gripping segment 14 being installed, “sitting” the gripping segment 14 on the access ramp 84. While holding the gripping segment 14 in place and slightly urging against the flange spring 95, the “seated” gripping segment 14 will move upward and click into place with respect to the spring-biased spacer 30. Then the user releases the flange 74, whereby the gripping segment 14 will be locked in or at least blocked from falling out (remember, some of these installation happen upside down with vertically oriented machine spindles 10). Moreover, when guiding said gripper segment 14 the flange 74 may be pulled proximally to create more room for the distal end 15 of the gripper segment 14 to slide around the shoulder 26 against the engager 84. Again, allowing the flange spring 95 to urge the flange 74 the forward/proximal, enables the access ramp 84 to block and apply pressure against the gripping segment 14, preventing its accidental dislodgement from the clamp set.

After the first gripper segment 14 has been sufficiently received to engage the engager 84 and be received, in part, in a recess 27 associated with the shoulder, the flange 74 may be rotated, which in turn rotates the sleeve 70 relative to the compressor body 40, for insertion of the next gripper segment 14. Here, the indicator 76 aids in proper rotation of the sleeve 70. Once all the gripper segments 14 have been installed, the installer may unscrew the installation device 100 from drawback 25 and remove installation device 100 from the spindle cartridge.

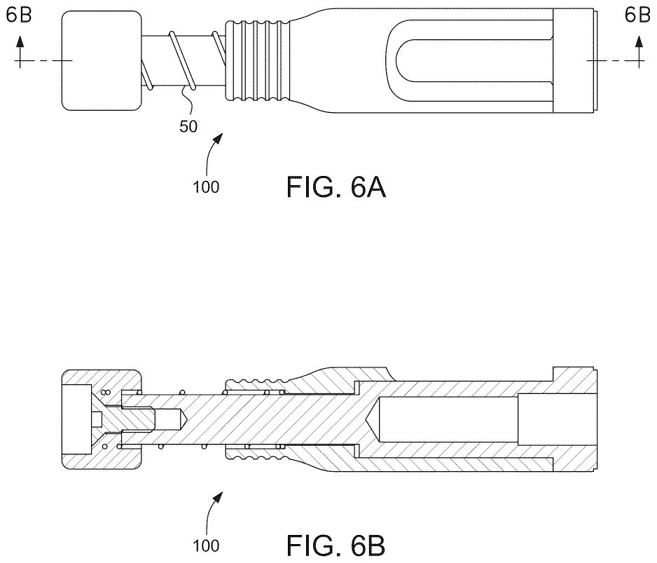

Referring to FIG. 6A-9C, alternative clamp set installation devices can be associated with different models of clamp sets, e.g., an ITB-100A/B125 model, with different geometry. The dimensions may be slightly different. It is understood by one skilled in the art that that subject disclosure has applicability beyond the dimensionality provided in this specification and figures; for instance, if there are different sized HSK clamp and drawbars, then the subject disclosure's dimensions may change while maintaining the same advantageous functionality disclosed herein.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A device for installing gripping segments of a clamping set for a machine spindle, the device comprising:
a compressor body having a shaft along which a sleeve is linearly movable relative to the shaft;
a distal portion of the compressor body configured to simultaneously (a) compress a spring of a spring-loaded spacer of said clamping set; and (b) engage a drawbar of said machine spindle; and
the sleeve having an access ramp along a distal end thereof, wherein the access ramp is configured to directly engage a gripping segment of said clamping set while operatively associating said gripping segment with the spring-loaded spacer.

2. The device of claim 1, wherein the distal portion defines a cavity having internal threads for threading onto said drawbar.

3. The device of claim 1, wherein the access ramp has a radius of curvature between a flat portion of the access ramp and an exterior wall of the sleeve.

4. The device of claim 1, wherein linear movement of the sleeve relative the shaft is deployed during operatively associating said gripping segment with the spring-loaded spacer.

5. The device of claim 1, wherein the sleeve is rotatable relative the shaft about a longitudinal axis thereof.

6. The device of claim 5, further comprising an indicator integrated to a proximal portion of the sleeve, wherein the indicator linearly aligns with the access ramp.

7. The device of claim 6, further comprising a radial flange along the proximal portion of the sleeve, wherein the indicator is a flat portion of the radial flange.

8. The device of claim 7, wherein the sleeve is biased in a relative direction of the distal portion of the compression body.

9. The device of claim 8, further comprising a grip knob connected to a proximal portion of the compressor body; and a spring operatively associated to the grip knob and the radial flange to bias the sleeve.

10. A method of installing a gripping segment into a spring-biased spacer operatively associated within a machine spindle, the method comprising:
compressing a spring of the spring-biased spacer with a distal portion of a tool, wherein the tool is simultaneously thread connected to a drawbar of the machine spindle; and
operatively associating the gripping segment with the spring-biased spacer by way of an access ramp provided by the tool, wherein the access ramp orients the gripping segment at a non-parallel angle relative to the distal portion of the tool during said operative association.
